(19) United States
(12) Patent Application Publication
(10) Pub. No.: US 2005/0215260 A1
(43) Pub. Date: Sep. 29, 2005

(54) Method and system for arbitrating between a local engine and a network-based engine in a mobile communication network

(75) Inventors: Deepak P. Ahya, Plantation, FL (US); Daniel A. Baudino, Lake Worth, FL (US); Sanigepalli V. Praveenkumar, Sunrise, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 10/806,989

(22) Filed: Mar. 23, 2004

(51) Int. Cl. H04Q 7/20

(52) U.S. Cl. 455/452.2; 455/450

(57) ABSTRACT

A method (50) of arbitrating the selection of engines between a local engine (24 or 124) and a network-based engine (36 or 136) in a mobile communication network for voice recognition or text conversion can include the step of determining at least one factor among an available bandwidth on a given channel (90), a signal quality on the given channel (94), a latency indication (58), a desired application need (62, 66, or 70), a cost factor (92), a background environment indication (84), and a number of unsuccessful attempts on the given channel and the step of automatically selecting (74) one among the local engine and the network-based engine based upon the at least one factor determined when performing at least one among voice recognition and text conversion.

### CROSS-REFERENCE TO RELATED APPLICATIONS

Not applicable.

### FIELD OF THE INVENTION

This invention relates in general to the use of local and network-based engines for voice recognition and text conversion, and more particularly to method and system of arbitrating the selection of such engines.

### BACKGROUND OF THE INVENTION

A mobile communication device architecture is typically optimized for minimizing power consumption and fails to match the performance capability of desktop computing stations in terms of MIPs or otherwise. High performance Voice Recognition (VR) engines are available on high performance server platforms, whereas speaker dependent recognition engines for name tag or digit dialing are available on mobile platforms. For applications that require very high quality voice recognition as well as high quality (natural) speech synthesis, a server solution is the most favored. For applications where the grammar is limited and time is of the essence, local recognition and local synthesis are desirable.

In a wireless mobile environment, existing systems have contemplated downloading larger grammar dictionaries from a remote server if a local dictionary was insufficient to process a particular input. There are also systems that use either a local engine or a remote engine, but not both. Nor is there any existing system that arbitrates between the use of a local engine or a remote engine based on factors specifically affecting a mobile environment.

### SUMMARY OF THE INVENTION

Embodiments in accordance with the invention illustrate systems and methods that intelligently use both local and network-based voice recognition (VR) and text-to-speech synthesis engines. As a result, an enhancement in the system level performance for the recognition rate for VR and the quality of speech for TTS can be achieved.

In a first aspect of an embodiment in accordance with the present invention, a method of arbitrating the selection of engines between a local engine and a network-based engine in a mobile communication network for voice recognition or text conversion (e.g., text-to-speech synthesis (TTS) or text synthesis) can include the step of determining at least one factor among an available bandwidth on a given channel, a signal quality on the given channel, a latency indication, a desired application need, a cost factor, a background environment indication (e.g., a background noise level or a predetermined background noise characteristic), and a number of unsuccessful attempts on the given channel and the step of automatically selecting one among the local engine and the network-based engine based upon the at least one factor determined when performing at least one among voice recognition and text conversion. Each of the factors that can be determined can be achieved in numerous ways. Some examples are provided. Determining the available bandwidth can involve detecting the available bandwidth at a given time period and automatically selecting among the local engine and the network-based engine can involve providing a recommended suggestion to a dialog manager for selection by a user. The step of determining the signal quality can include the step of measuring signal strength between a portable communication unit and a base station. The step of determining the cost factor can include the step of determining a cost associated with communication in at least one among a predetermined number of networks. The step of determining the latency indication can include the step of measuring a delay that the mobile communication network experiences to process a request compared to a predetermined threshold. The step of determining the background environment indication can include the step of measuring a background noise level compared to a threshold level of noise. The step of determining the number of unsuccessful attempts can include the step of accounting for the number of unsuccessful attempts in voice recognition in comparison to a predetermined number. The step of determining the desired application need can involve determining at least one among a quality level of processing required, a speed requirement, and a grammar and language dictionary requirement. Note that the automatically selected engine(s) can be used either for performing voice recognition or text conversion.

In a second aspect, a mobile communication system having an arbitrated selection between a local engine and a network-based engine for voice recognition or text conversion can include at least one remote server having the network-based engine, and a portable communication unit having the local engine and a processor. The processor in the portable communication unit can be programmed to determine at least one factor among an available bandwidth on a given channel, a signal quality on the given channel, a latency indication, a desired application need, a cost factor, a background environment indication, and a number of unsuccessful attempts on the given channel and to automatically select one among the local engine and the network-based engine based upon the at least one factor determined when performing at least one among voice recognition and text conversion. As explained above, the processor can programmed to determine many factors. For example, the processor can be programmed to determine the signal quality by measuring signal strength between a portable communication unit and a base station. The processor can be further programmed to automatically select by weighting the selection for the local engine in a weak signal environment and weighting the selection for the network-based engine in a strong signal environment such that the weak signal environment or the strong signal environment is determined using at least one threshold value.

In a third aspect, a mobile communication system having an arbitrated selection between a local engine and a network-based engine for voice recognition or text conversion can include at least one remote server having the network-based engine and a remote processor, and a portable communication unit having the local engine and a local processor. In this embodiment, at least one among the remote processor and the local processor can be programmed to determine at least one factor among an available bandwidth on a given channel, a signal quality on the given channel, a latency indication, a desired application need, a cost factor, a background environment indication, a number of unsuccessful attempts on the given channel, and a server traffic condition and to automatically select one among the local engine and the network-based engine based upon the at least one factor determined when performing at least one among voice recognition and text conversion.

In a fourth aspect, a mobile communication unit that arbitrates a selection between a local engine and a network-based engine for voice recognition or text conversion can include a transceiver unit coupled to a processor and a local engine. The transceiver unit can communicate with a remote server having the network-based engine. The processor can be programmed to determine at least one factor among an available bandwidth on a given channel, a signal quality on the given channel, a latency indication, a desired application need, a cost factor, a background environment indication, and a number of unsuccessful attempts on the given channel and to automatically select one among the local engine and the network-based engine based upon the at least one factor determined when performing at least one among voice recognition and text conversion.

### BRIEF DESCRIPTION OF THE DRAWINGS

FIG. 1 illustrates a system flow diagram in accordance with an embodiment of the present invention.

FIG. 2 shows a high level architecture for a network-based engine and a local engine for voice recognition in accordance with an embodiment of the present invention.

FIG. 3 illustrates a flow chart of a method of selecting either a local or network-based voice recognition engine in accordance with an embodiment of the present invention.

FIG. 4 illustrates a sequence diagram using both a local engine and a network-based engine in accordance with an embodiment of the present invention.

FIG. 5 illustrates a state diagram of a method of engine selection in accordance with an embodiment of the present invention.

FIG. 6 shows a high level architecture for a network-based engine and a local engine for text conversion in accordance with an embodiment of the present invention.

### DETAILED DESCRIPTION OF THE DRAWINGS

While the specification concludes with claims defining the features of the invention that are regarded as novel, it is believed that the invention will be better understood from a consideration of the following description in conjunction with the drawing figures, in which like reference numerals are carried forward.

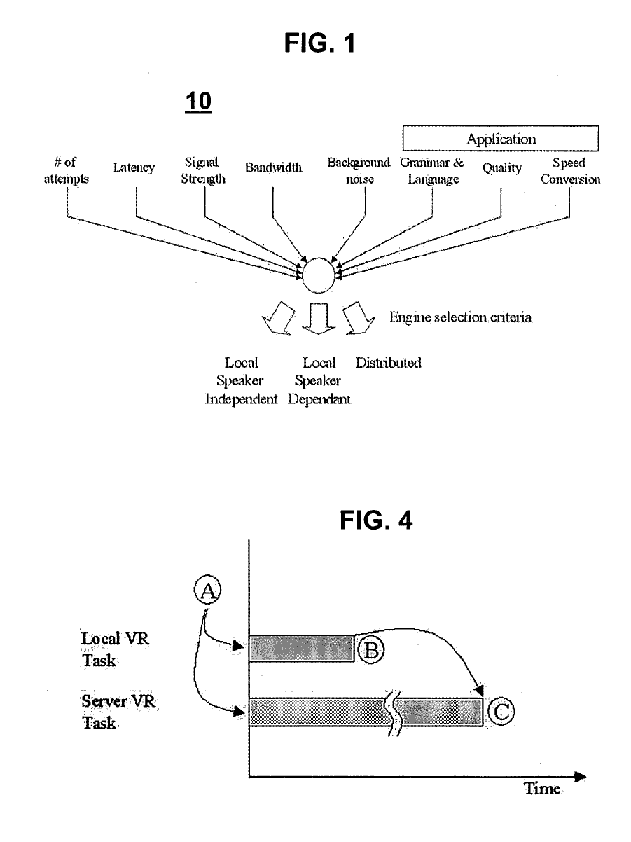

Referring now to FIG. 1, a system flow diagram 10 illustrates that the selection algorithm for selecting either a local engine or a distributed or network-based engine for voice recognition takes into account many factors. Note that a local engine can include either a local speaker dependent engine (higher quality) or a local speaker independent engine. The selection algorithm can account and make decision based upon factors such as the bandwidth available, signal quality, cost factors, latency, unsuccessful recognition attempts, background environment, and application needs. Each of these factors will be discussed in further detail below.

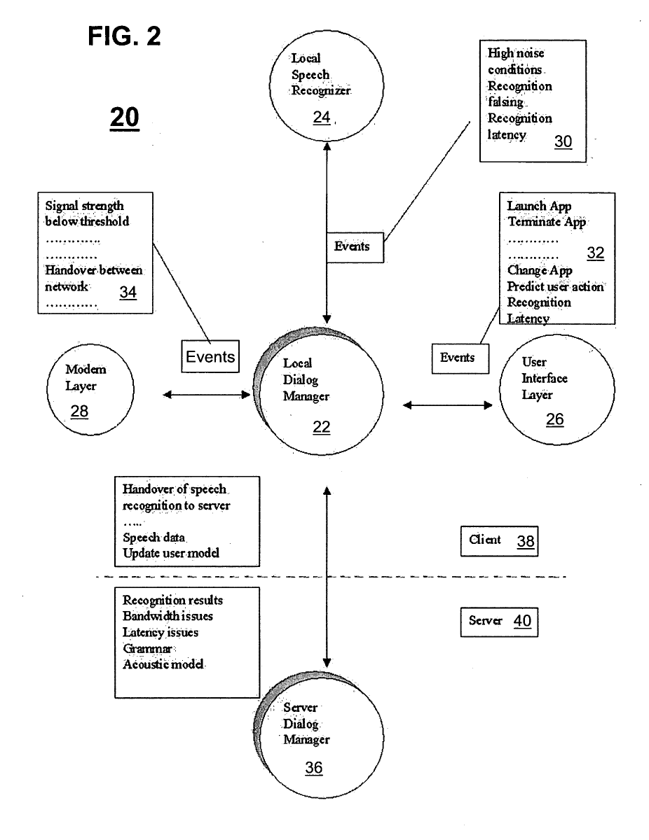

The bandwidth available can be detected by the system 10 at the moment required to make a decision on which engine to use. In a high data rate network such as WLAN, the algorithm can select the network-based engines. Referring to the high level architecture 20 of FIG. 2, a modem layer 28 can detect the network or networks present, and make a suggestion to a Dialog Manager 22 or 36 to decide what engine to use on either a client side 38 or a server side 40 respectively. If the local dialog manager 22 is used to provide the suggestion, a user interface layer 26 can be used to enable a user to make the ultimate selection between engines regardless of the suggestion. If high noise conditions or high falsing or long latency exists (30), then the local VR engine 24 can be selected. If an application or user prefers speed of processing over quality of results (32), then the local VR engine can also be selected. If the signal strength falls below a predetermined threshold (34), then the local VR engine 24 can also be selected.

In determining signal quality and preventing high error rates, the system 10 can measure signal strength. In a low signal strength environment, the algorithm can select the local version of the engine. The dialog manager (22 or 36) (VR selection) can use the signal quality to make a decision between the local or the server version. If the signal quality (i.e. RSSI) goes down below a certain threshold (predetermined by the system) and the VR engine selected is the server version, then the dialog manager can choose to use the local version to prevent retransmission and poor quality conversions. Contrastly, if the signal quality or RSSI goes up, the system can automatically switch to the server engine. A hysteresis window can be provided to avoid false switches.

With respect to cost, a user can set up a cost preference (or preferred network). There are several wireless networks available (WLAN, iDEN, GSM, CDMA, 3G, etc) and each has a different cost structure for the user. The proposed methodology can factor the cost into the decision algorithm. A user can also enter their cost preferences (versus performance) enabling the system 10 to take cost into account. For example, if a user enters a zone (roaming to a new network), the system can detect the new network and based on cost, switch to the new network or not. The cost information can be prerecorded on the phone or directly downloaded from the network. More specifically, if WLAN service is available with a flat fee structure, the user may want to switch from a cellular service to the WLAN service for cost purposes, not to mention the likely advantage with respect to bandwidth.

The algorithm can also measure the delay that the system 10 takes to process a request and compare it to a predetermined threshold for example. Based on the measured delay, the algorithm can then make a decision on what system to choose. The algorithm can also account for the number of unsuccessful attempts in recognition when making a decision on which engine to use. A threshold can be set to the number of attempts enabling the algorithm can make a decision on which system to choose. When the background is noisy, the algorithm can choose to use the network-based or distributed version as the recognition becomes more difficult. Of course, each of these factors can be weighted or given priority as desired.

The application selected by the user can have the ability to feed the algorithm with different application's needs that will affect the choice of engine(s). For example, an application (or user preference for the application) requiring high quality processing in terms of recognition would favor a network-based engine, whereas an application requiring speed of conversion (where conversion time is critical for the application) would favor a local engine. In the case where a grammar or language dictionary is required for an application that is unavailable or insufficient in a local form, then the application can request a new grammar or language dictionary, so the algorithm can either download it to use the local engine or send the request to the network-based engine for remote processing. Of course, the algorithm can also monitor the user patterns to enhance the local recognition engine (such as in a speaker dependent engine) and download new grammars (dictionaries), acoustic models, languages, and common words as examples and as available and appropriate.

Between the local recognition engines, a speaker dependant recognition is more accurate than the speaker independent. This criterion can be added to the decision algorithm. If a particular speaker always uses the device, the local version of the speaker dependant engine can have priority in most instances. The user can be detected using speaker verification techniques known in the art.

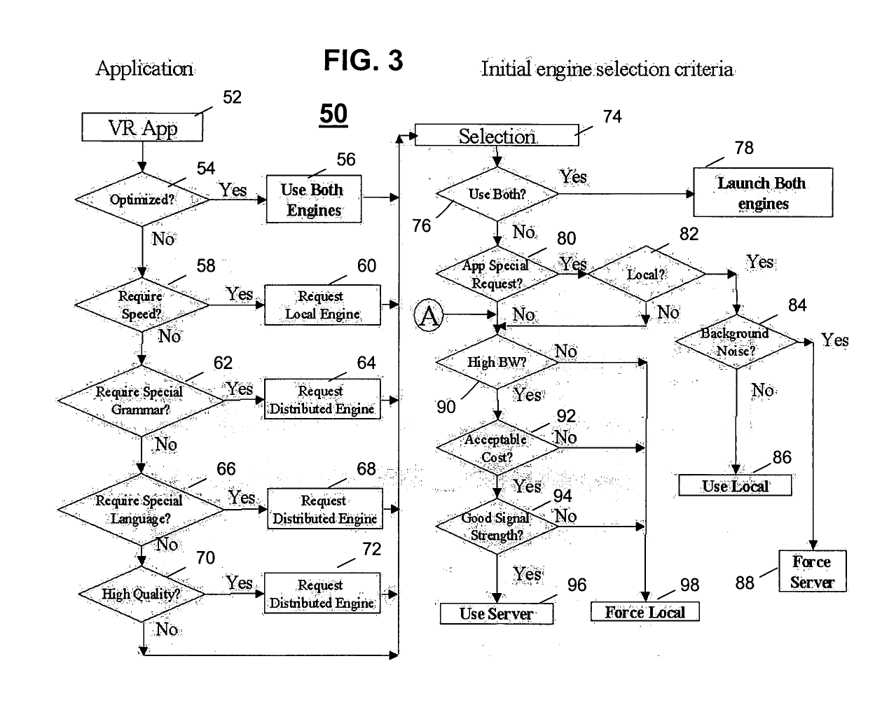

Referring to FIG. 3, a flow chart of a VR engine decision method 50 is shown. A voice recognition application 52 first checks, based on its preferences, what engine to choose. The application can have several options including a Local engine 86, a Server engine 96, both engines 98, and a best or forced option (88 or 98) that allows the system to select the best engine under the circumstances. If an optimized VR is desired at decision block 54, then use of both engines is recommended at block 56. If speed is a consideration at decision block 58, then use of the local engine is recommended at block 60. If a special grammar or language is desired at decision blocks 62 or 66 respectively, then a network-based or distributed engine is recommended at blocks 64 or 68 respectively. Finally, if a high quality recognition process is desired (e.g., beyond the capabilities of the local engine), then the network-based engine will also be requested.

After the decision is made at block 74, a local Dialog Manager (DM) can verify if it is possible to grant the application request. The first verification of the DM is if the application pre-selected the engine to use both engines at decision block 76. If both engines are to be used, then both engines are launched at block 78. If a single engine was selected, then the DM verifies if the application has some other preferences at decision block 80. If a local server is preferred at decision block 82, then background noise can be assessed whether it exceeds a threshold at decision block 84. In other words, the VR engine measures the noise level and informs the DM with the decision. If no appreciable background noise (or an acceptable level) is measured, then the DM selects and the method 50 uses the local engine at block 86. If appreciable background noise (or an unacceptable level) is measured at decision block 84, the server engine at block 88 is used overriding the initial application preference. Since the application did not request this engine, the DM grants temporary access to the server engine (Force server). This means that the DM will keep verifying the background to select the local version. When the application has no preference or best engine, the DM can assume by default the server engine (although, the no “preference/best engine” can be configured by the user to be the local engine or both engines).

If the server version is requested at decision block 82 (or no preference as indicated at decision block 80), then the selection engine goes into a series of verifications. At decision block 90, the Modem Layer can inform the local DM with the decision based on network availability (WLAN, 2.5G, 3G, etc.). If a high bandwidth network is unavailable at decision block 90, then the systems forces the use of the local engine at block 98. Next, based on User Preferences and Server DM information (Cost information from the network), a decision whether to use a network-based engine can be determined at decision block 92. If the cost determined is unacceptable, then the local engine is used again at block 98. With respect to signal quality, the Modem Layer can inform the local DM with the level of the signal strength at decision block 94. If signal strength or quality is poor, then once again, the method forces the use of the local engine at block 98. If the bandwidth, cost and signal quality factors are favorable and all the respective verifications are successful, then the server engine is selected for the application at block 96 and the DM provides access to the server engine.

Again, if at least one of the verification fails, then the engine selected is the local engine. Since the application did not request this engine, the DM grants temporary access to the local engine (Force Local) at block 98. This means that the DM will keep verifying to find the acceptable parameters for the server version.

Referring to FIG. 4, a sequence diagram illustrates over time what occurs when both engines are selected. The DM (A) starts the recognition on the local and the server version. The recognition will likely be reached first on the local version (B) (due to a lack of network latency). If the recognition (or conversion) was successful and the application accepts the result, the server version can be stopped. If the recognition was unsuccessful or if the application rejects the results, the system can Wait until the server version finalizes the conversion. Once the server conversion is ready (C) with the result that is considered successful, it can be accepted by the application. The results from B and C can both be used and compared to get the best conversion. Using this methodology, the application is optimized for the given overall conversion time.

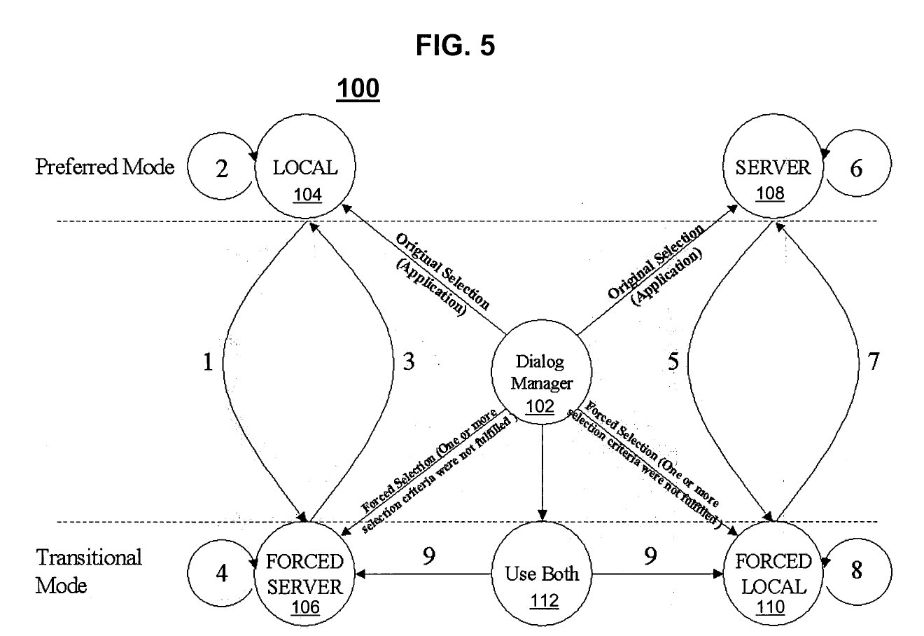

Referring to FIG. 5, a state diagram 100 for selection of a local or and/or network-based engine is shown. After the engine was selected as shown in FIG. 3, either for the application or forced by the DM, the recognition is started. The DM keeps monitoring the selection criteria and makes decisions if needed. The state changes are based on decisions made by a DM 102 as follows: If the engine is in the preferred mode (say local engine 104), the DM 102 can monitor the background noise and the # of attempts. If any of those parameters changes and reaches a level that is not accepted by the DM 102, then the DM 102 changes mode. The preferred mode changes to the transitional mode (forced server option 106). The DM 106 first checks if the forced server is an option (see entry point A on the flow diagram of FIG. 3). During the preferred mode, the DM 102 keeps monitoring the background noise and # of attempts to verify if all the parameters remain normal. If the Server option 106 was forced (transitional mode), the DM 102 keeps monitoring for changes in bandwidth, background noise, cost, and number of unsuccessful attempts. If any one or more of those parameter changes reaches unacceptable limits, the DM 102 modifies the state back to the local engine 104 (to the original decision made by the application-Preferred mode). The background noise and the number of attempts needs to reach acceptable limits for the DM 102 to make a change state decision (go back to 106). If all the parameters remain the same and there is no state change, the system keeps using the transitional mode.

If the server engine 108 is selected by the application or a change of state, the DM 102 keeps monitoring the bandwidth, latency, signal strength and the number of attempts and verifies if those parameters are under normal conditions. If any of those parameters changes and reaches unacceptable limits, then the DM 102 changes the engine to the transitional mode (Forced Local 110). If all the parameters remain the same, there is no state change, the system keeps using the preferred mode. If the selected engine is in the local forced option 110 (in Transition mode) or in a change of state, the DM 102 keeps monitoring the bandwidth, number of attempts, signal strength, cost changes, etc. If all parameters reach acceptable limits, then the DM 102 can change the state back to the server engine 108 (original decision made by the application). If all the parameters remain the same, there is no state change, and the system keeps using the transitional mode. When both engines are used at 112, the DM 102 keeps monitoring all the parameters (for example, if no network is available), and in some extreme cases the engine might be forced to either the local or server engine.

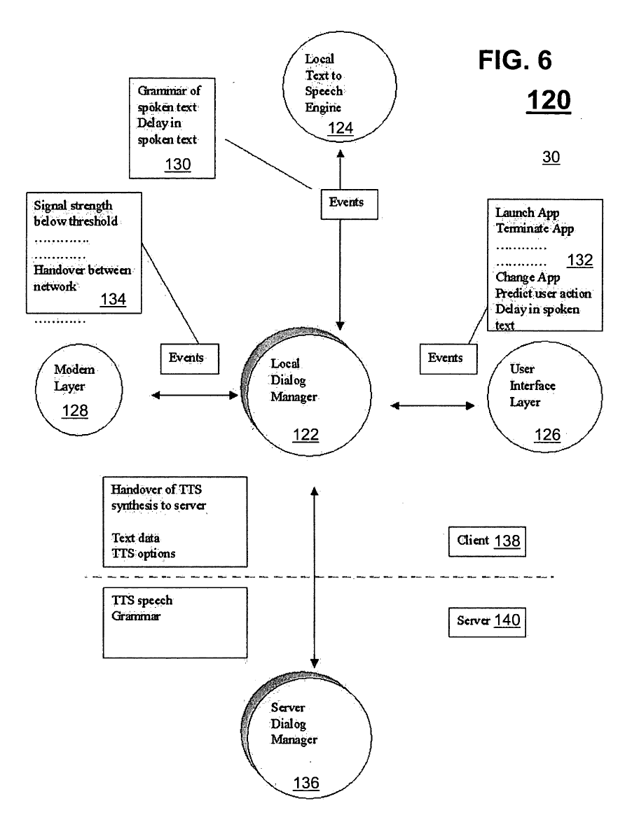

Referring to FIG. 6, a high level architecture 120 is shown in the context of a local and distributed (or network-based) text-to-speech synthesis (TTS) system. The architecture 120 can include a modem layer 128 that detects the network or networks present, and make a suggestion to a Dialog Manager 122 or 136 to decide what engine to use on either a client side 138 or a server side 140 respectively. The Local TTS version may have a limited vocabulary due to a memory size constraint. The Local TTS version can also be susceptible to quality issues again due to memory size or processing power. Thus, a network-based TTS version makes for a good alternative for a local TTS version, even for a high quality TTS conversion on a handheld device. If the local dialog manager 122 is used to provide the suggestion, a user interface layer 126 can be used to enable a user to make the ultimate selection between engines regardless of the suggestion. If long latency exists (130 or 132), then the local TTS engine 124 can be selected. If an application or user prefers speed of processing over quality of results (132), then the local TTS engine can also be selected. If the signal strength falls below a predetermined threshold (134), then the local TTS engine 124 can also be selected.

Note, the selection algorithm for TTS conversion in FIG. 6 can be quite similar to the algorithm used for VR as shown in FIG. 2. The system can detect the bandwidth available at the moment to make a decision on what system to use. Usually in high rate networks such as WLAN, the algorithm can select the distributed or network-based engines. To prevent high error rate, the system can measure the signal strength. In low signal strength, the algorithm can select the local version of the engine. The algorithm can also measure the delay that the system takes to process a request, and then compare it to a predetermined threshold, whereupon the algorithm can make a decision on what system to choose. As previously described with VR, the application can have the ability to feed the algorithm with different applications needs such as High Quality processing (where the algorithm prefers the distributed version) or Speed of conversion (where a local version would be optimal for applications where the conversion time is critical). Additionally, grammar & language dictionaries required for the application can be requested and the algorithm can either download the appropriate dictionary to use with the local engine or send the request to the distributed engine for remote processing.

In summary, the architecture as depicted in FIG. 1 gives a framework to implement an algorithm that can switch between local and distributed Speech recognition systems. There are several events that influence the decision between choosing local versus network-based (or distributed). Such events include a handover due to poor coverage in a current network, availability of a cheaper network and a bandwidth option, a low signal to noise ratio, a change in bandwidth conditions such as allocation of less bandwidth, recognition falsing, recognition latency, and noisy background conditions.

As shown in FIG. 2, the architecture likewise gives a framework to implement an algorithm that can switch between local and network-based (or distributed) text to speech synthesis (TTS) systems. Once again, there are several events that influence the decision between choosing local versus distributed. Such events include a handover due to poor coverage in a current network, availability of a cheaper network and a bandwidth option, a low signal to noise ratio, a change in bandwidth conditions such as an allocation of less bandwidth, a grammar availability, and a synthesis delay.

One practical example can be illustrated in the case of requesting and receiving driving directions. This application can provide a mechanism for a user to request and receive driving directions via speech. Due to the limitations on a mobile device, the voice recognition engine may not necessarily hold all the street names on its database for the local speech recognition. A distributed or network-based voice recognition engine becomes the ideal solution when using directions (street names, etc). When using the system (network-based), the user might enter an area with poor reception or no reception at all. The driving direction application (using the network-based engine) becomes obsolete, preventing user to ask for directions. The proposed solution allows the system to switch to the local engine and limited version of the voice recognition allowing the user to access the application for simple requests.

Likewise, with TTS, the server solution can be ideal, but if the system cannot deliver the best solution, the system can automatically select a limited local TTS version. In this manner, the user does not loose the ability to get driving directions via synthesized voice.

In another example for air travel reservations, a user may perform one or more among name or number dialing and command or control operations. The user can say a name or a number into a mobile device. An illustrative use case for this application is when a user is driving. While driving, the user can benefit from hands and eyes free operation. Noise may be present while the user tries to use the name/number dialing application. With the current technology, the user will not be able to use the speech recognition feature of the application when most needed. The proposed solution can automatically switch to the network-based (or distributed) recognition engine (a more noise robust solution). Also, the user can have their contact list stored locally as well as on the server. The system application can select the local engine, but if the number of attempts is too high, then the system can automatically switch to the server version. This way, the user has a more robust VR engine available for use by the mobile unit.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, any discussion of such software and ICs, if any, was limited to the essentials with respect to the principles and concepts of the preferred embodiments.

In light of the foregoing description, it should be recognized that embodiments in accordance with the present invention can be realized in hardware, software, or a combination of hardware and software. A communications system or device according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

Additionally, the description above is intended by way of example only and is not intended to limit the present invention in any way, except as set forth in the following claims.

1. A method of arbitrating the selection of engines between a local engine and a network-based engine in a mobile communication network for voice recognition or text conversion, comprising the steps of:
determining at least one factor among an available bandwidth on a given channel, a signal quality on the given channel, a latency indication, a desired application need, a cost factor, a background environment indication, and a number of unsuccessful attempts on the given channel; and
automatically selecting one among the local engine and the network-based engine based upon the at least one factor determined when performing at least one among voice recognition and text conversion.

2. The method of claim 1, wherein the step of determining the available bandwidth comprises the step of detecting the available bandwidth at a given time period and the step of automatically selecting comprises the step of providing a recommended suggestion among the local engine and the network-based engine to a dialog manager for selection by a user.

3. The method of claim 1, wherein the step of determining the signal quality comprises the step of measuring signal strength between a portable communication unit and a base station.

4. The method of claim 3, wherein the step of automatically selecting comprises the step of weighting the selection for the local engine in a weak signal environment and weighting the selection for the network-based engine in a strong signal environment wherein the weak signal environment or the strong signal environment is determined using at least one threshold value.

5. The method of claim 1, wherein the step of determining the cost factor comprises the step of determining a cost associated with communication in at least one among a predetermined number of networks.

6. The method of claim 1, wherein the step of determining the latency indication comprises the step of measuring a delay that the mobile communication network experiences to process a request compared to a predetermined threshold.

7. The method of claim 1, wherein the step of determining the background environment indication comprises the step of measuring a background noise level compared to a threshold level of noise.

8. The method of claim 1, wherein the step of determining the number of unsuccessful attempts comprises the step of accounting for the number of unsuccessful attempts in voice recognition in comparison to a predetermined number.

9. The method of claim 1, wherein the step of determining the desired application need comprises the step of determining at least one among a quality level of processing required, a speed requirement, and a grammar and language dictionary requirement.

10. The method of claim 1, wherein the method further comprises the step of using the automatically selected engine for performing at least one of the functions of voice recognition and text conversion.

11. A mobile communication system having an arbitrated selection between a local engine and a network-based engine for voice recognition or text conversion, comprising:
at least one remote server having the network-based engine;
a portable communication unit having the local engine and a processor, wherein the processor is programmed to:
determine at least one factor among an available bandwidth on a given channel, a signal quality on the given channel, a latency indication, a desired application need, a cost factor, a background environment indication, and a number of unsuccessful attempts on the given channel; and
automatically select one among the local engine and the network-based engine based upon the at least one factor determined when performing at least one among voice recognition and text conversion.

12. The system of claim 11, wherein the processor is further programmed to determine the available bandwidth by detecting the available bandwidth at a given time period and to automatically select by providing a recommended suggestion among the local engine and the network-based engine to a dialog manager for selection by a user.

13. The system of claim 11, wherein the processor is further programmed to determine the signal quality by measuring signal strength between a portable communication unit and a base station.

14. The system of claim 13, wherein processor is further programmed to automatically select by weighting the selection for the local engine in a weak signal environment and weighting the selection for the network-based engine in a strong signal environment wherein the weak signal environment or the strong signal environment is determined using at least one threshold value.

15. The system of claim 11, wherein the processor is further programmed to determine at least one among the cost factor, the latency indication, the background environment indication or the number of unsuccessful attempts by respectively determining a cost associated with communication in at least one among a predetermined number of networks, measuring a delay that the mobile communication network experiences to process a request compared to a predetermined threshold, measuring a background noise level compared to a threshold level of noise or accounting for the number of unsuccessful attempts in voice recognition in comparison to a predetermined number.

16. The system of claim 11, wherein the processor is further programmed to determine the desired application need by determining at least one among a quality level of processing required, a speed requirement, and a grammar and language dictionary requirement.

17. A mobile communication system having an arbitrated selection between a local engine and a network-based engine for voice recognition or text conversion, comprising:
at least one remote server having the network-based engine and a remote processor;
a portable communication unit having the local engine and a local processor, wherein at least one among the remote processor and the local processor is programmed to:
determine at least one factor among an available bandwidth on a given channel, a signal quality on the given channel, a latency indication, a desired application need, a cost factor, a background environment indication, a number of unsuccessful attempts on the given channel, and a server traffic condition; and
automatically select one among the local engine and the network-based engine based upon the at least one factor determined when performing at least one among voice recognition and text conversion.

18. A mobile communication unit that arbitrates a selection between a local engine and a network-based engine for voice recognition or text conversion, comprising:
a transceiver unit coupled to a processor and a local engine, the transceiver unit being in communication with a remote server having the network-based engine, wherein the processor is programmed to:
determine at least one factor among an available bandwidth on a given channel, a signal quality on the given channel, a latency indication, a desired application need, a cost factor, a background environment indication, and a number of unsuccessful attempts on the given channel; and
automatically select one among the local engine and the network-based engine based upon the at least one factor determined when performing at least one among voice recognition and text conversion.

19. The mobile communication unit of claim 18, wherein the processor is further programmed to determine the available bandwidth by detecting the available bandwidth at a given time period and to automatically select by providing a recommended suggestion among the local engine and the network-based engine to a dialog manager for selection by a user.

20. The mobile communication unit of claim 18, wherein the processor is further programmed to determine the signal quality by measuring signal strength between a portable communication unit and a base station.

21. The mobile communication unit of claim 20, wherein processor is further programmed to automatically select by weighting the selection for the local engine in a weak signal environment and weighting the selection for the network-based engine in a strong signal environment wherein the weak signal environment or the strong signal environment is determined using at least one threshold value.

22. The mobile communication unit of claim 18, wherein the processor is further programmed to determine at least one among the cost factor, the latency indication, the background environment indication or the number of unsuccessful attempts by respectively determining a cost associated with communication in at least one among a predetermined number of networks, measuring a delay that the mobile communication network experiences to process a request compared to a predetermined threshold, measuring a background noise level compared to a threshold level of noise or accounting for the number of unsuccessful attempts in voice recognition in comparison to a predetermined number.

23. The mobile communication unit of claim 18, wherein the processor is further programmed to determine the desired application need by determining at least one among a quality level of processing required, a speed requirement, and a grammar and language dictionary requirement.
